(19) United States
(12) Patent Application Publication
(10) Pub. No.: US 2012/0121930 A1
(43) Pub. Date: May 17, 2012

(54) Metallic Composite Comprising a Load-Bearing Member and a Corrosion Resistant Lager

(76) Inventors: Kenneth Göransson, Gavle (SE); Mats Lundberg, Sandviken (SE)

(21) Appl. No.: 11/990,486

(22) PCT Filed: Aug. 16, 2006
(86) PCT No.: PCT/SE2006/050284

§ 371 Date: Jun. 17, 2010

(30) Foreign Application Priority Data
Aug. 19, 2005 (SE) 0501838-7

(51) Int. Cl. B32B 15/01; C23C 30/00; B32B 15/20; B32B 15/18

(52) U.S. Cl. 428/653; 428/652

(57) ABSTRACT

A composite material intended for components used in corrosive environments, wherein said material comprises a corrosion-resistant part and a load-bearing part, wherein said parts are disposed adjacent one another, wherein the corrosion-resistant part is a copper-aluminium alloy (Cu/Al) and wherein the load-bearing part is comprised of an iron-based (Fe), a nickel-based (Ni) or a cobalt-based (Co) alloy. The invention is characterized in that the diffusion barrier is disposed between the corrosion-resistant part and the load-bearing part, and in that the diffusion barrier contains one of the substances chromium (Cr) or iron (Fe) or iron (Fe) that contains one of the alloying substances chromium (Cr) or carbon (C).

The present invention relates to a composite material that comprises a load-carrying part and a corrosion-resistant part.

A particular application of said composite material is found in composite tubes or pipes. The International Public Specification WO2005/021255 describes composite tubes of varying construction and problems concerning different types of corrosion to which such composite tubes can be subjected in different types of industries, such as the petrochemical industry.

According to this International application the problem is solved with a composite tube that includes a corrosion-resistant part and a load-bearing part. The corrosion-resistant part is comprised of a copper-aluminium alloy which has a wall thickness of at least 0.5 mm. The load carrying part is comprised of an iron, nickel or cobalt based alloy which has a wall thickness of at least 1 mm. A composite tube of this nature can be produced with the aid of conventional methods, such as extrusion, rolling, welding, etc. Such composite tubes are intended for use in environments in which there is a serious danger of corrosion, such as in so-called metal dusting, carbonization or re-carburization processes.

However, problems can arise with this kind of composite tubes over a period of time. One problem is that the resistance of such pipes to corrosion can be impaired, and also that the mechanical strength of the load bearing part can also be impaired. Another problem is that the bond between said two parts can be impaired with time.

These problems are overcome by means of the present invention. The present invention relates, however, to a composite material which can be used in applications other than tubes in said environments. Thus, the present invention is not limited to composite tubes but can also be applied in respect of planar products or products of some other configuration.

The present invention thus relates to a composite material for components intended for use in corrosive environments and comprising a corrosion-resistant part and a load-bearing part, wherein said parts are disposed adjacent one another, wherein the corrosion-resistant part is a copper-aluminium alloy (Cu/Al) and where the load-bearing part is an iron (Fe) nickel (Ni) or cobalt-based (Co) alloy and is characterized by a diffusion barrier disposed between the corrosion-resistant part and the load-bearing part, and wherein the diffusion barrier includes one of the substances chromium (Cr) or iron (Fe) or iron (Fe) with the alloying substances chromium (Cr) or carbon (C).

The present invention will now be described in more detail partly with reference to an embodiment of the invention illustrated in the figures of the accompanying drawing, in which

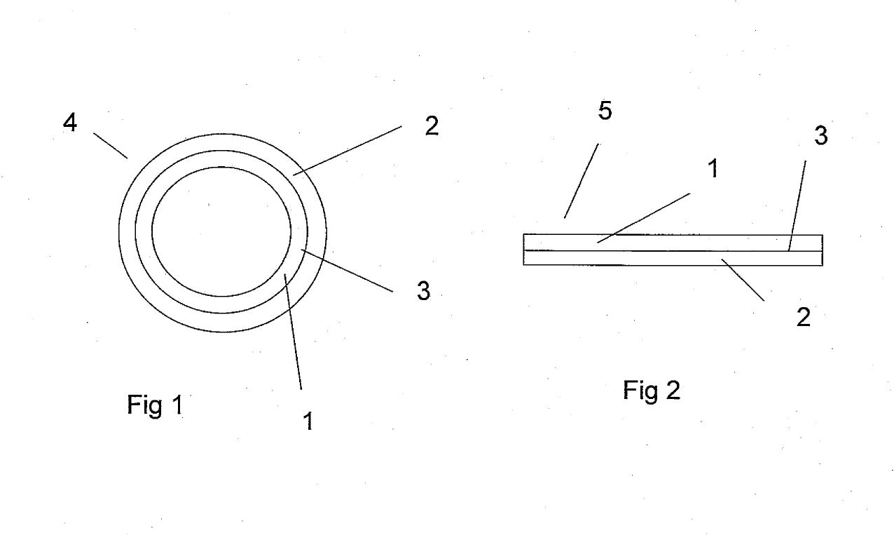

FIG. 1 illustrates the inventive composite material in the form of a tube or pipe;

FIG. 2 illustrates the inventive composite material in the form of a planar element; and

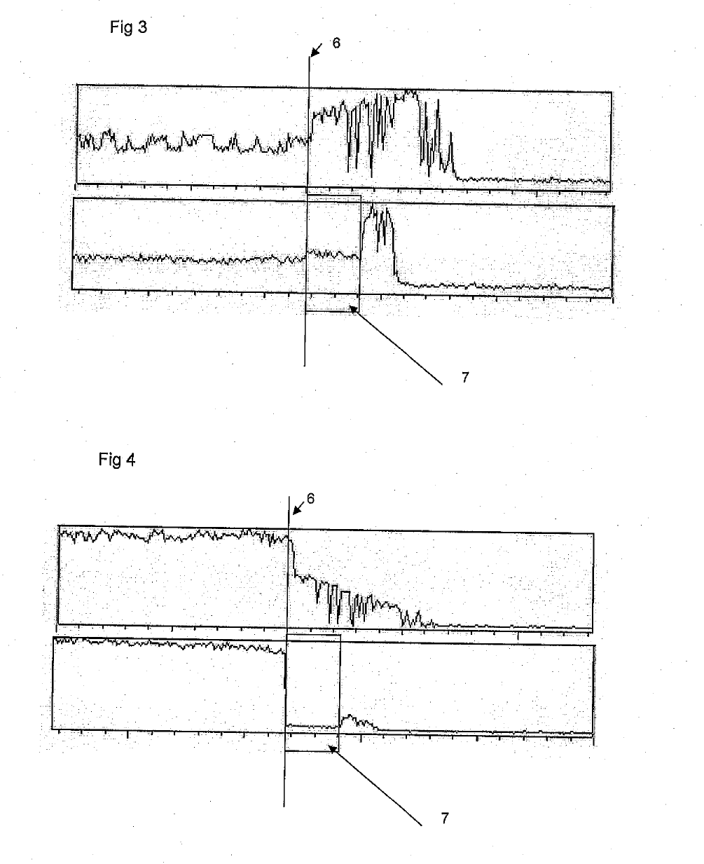

FIGS. 3 and 4 each comprise a diagram.

The present invention relates to a composite material for components that are subjected to corrosive environments, said material comprising a corrosion-resistant part and a load-bearing part, said parts being disposed adjacent one another. The corrosive-resistant part is comprised of a copper-aluminium alloy and the load-bearing part is an iron-based, a nickel-based or a cobalt-based alloy.

According to the present invention a diffusion barrier is disposed between the corrosion-resistant part and its load-bearing part, wherein the diffusion barrier contains one of the substances chromium (Cr) or iron (Fe) or iron (Fe) containing the alloying substances chromium (Cr) or carbon (C).

The diffusion barrier may thus consist essentially of pure iron or essentially of pure chromium. Moreover, the diffusion barrier may contain iron with chromium or carbon as the alloying substances.

There will now be described the case when the diffusion barrier contains iron with chromium or carbon as the alloying substances.

FIG. 1 illustrates the inventive composite material in the form of a tube 4. FIG. 2 shows the inventive composite material in the form of a planar element. The figures are not shown in accordance with any particular scale.

The corrosive-resistant part of the material is referenced 1 in both figures and the load-bearing part of the material is referenced 2 and the diffusion barrier is referenced 3. The present invention, however, is not limited to these embodiments. On the contrary, the present invention can be applied to all manner of shapes and can also be applied in a manner which enables entire components of any desired shape or configuration to be formed by the inventive material.

As a result of the invention, the extent to which Cu diffuses in the load-bearing part of the material is restricted at temperatures above 400-500° C., such diffusion otherwise weakening the load-bearing part mechanically. Also restricted is the diffusion of Al and Ni in towards the bonding zone between said parts, where a brittle bond Ni Al would be formed as a totally covering layer in the bonding zone. In the absence of a diffusion barrier the solubility of Cr in Ni Al would result in the separation of brittle Cr-rich Ferrite from the load-bearing material formed in the Ni Al, therewith further increasing the brittleness.

Moreover, Ni would diffuse into the Cu-Al-alloy in the absence of the diffusion barrier, i.e. into the corrosion-resistant part and up to its free surface, therewith impairing antic corrosion properties.

Thus, according to the present invention, an Fe-base alloy is provided as a diffusion barrier between the corrosion-resistant Cu-Al-alloy and the Fe/Ni/Cr-alloy containing the load-bearing Ni/Co-substance.

The diffusion barrier is relatively thin.

According to one preferred embodiment, the diffusion barrier has a thickness of at least 10 μm

Furthermore the diffusion barrier has a thickness that does not exceed roughly 25% of the total wall thickness of the composite material. The total thickness will normally range from 1 to 10 mm, although it may be as much as one meter. Preferably, the thickness of the diffusion barrier will not exceed 2-3 mm, since no additional effect can be achieved with thicker diffusion barriers.

It is also preferred that the corrosion-resistant part of the material is sufficiently thick to achieve its intended purpose and a desired length of life. This thickness, however, will preferably not exceed 10 mm.

The thickness of the load-bearing part is determined by the stresses to which it will be subjected in respect of its application.

The composite material is required in said environments at temperatures in excess of 400-600° C., depending on application, and function in the manner described at temperatures up to 850-1000° C. depending on application.

The function of the diffusion barrier is as follows. Cu has a low solubility in Fe, resulting in a much lower diffusion of Cu into the load-bearing part.

A marginal diffusion-preventing effect is obtained with respect to Al.

With respect to the alloying substances chromium or carbon, the diffusion barrier shall not contain both chromium and carbon.

Cr results in a lower solubility of Cu in Fe. Furthermore, Cr makes the diffusion barrier ferric in a given larger temperature range. At Cr-contents>13%, the alloy is ferric at all temperatures. Ferric Fe dissolves less Cu than austenitic Fe.

Moreover, the solubility of Ni and Co is restricted in a ferric material, which keeps the diffusion rate down.

Cr lowers the solubility of Ni, partly by stabilizing the ferrite so that it is stable within a higher temperature range, and partly by directly reducing the solubility of Ni in the ferrite by increasing the Cr-content.

Cr also seems to lower the solubility of Al.

According to one preferred embodiment of the invention, the alloying substance chromium is present in an amount within the range of 1-30% by weight.

The alloying substance C means that the diffusion barrier will be austenitic within a given higher temperature range, mainly above 732° C. Al has a low solubility in austenite that is free from Ni and, furthermore the diffusion rate is significantly lower in austenite than in ferrite.

According to one preferred embodiment of the invention, the alloying substance carbon is present in an amount at which the iron is austenitic at the temperature used.

One benefit afforded by the austenitic diffusion barrier is that it results in a smaller difference in thermal expansion than when the diffusion barrier is ferric.

According to one preferred embodiment the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance Cu and normally occurring alloying elements and contaminants.

According to another preferred embodiment of the invention the load-bearing part has the following composition in percent by weight:

| | |
|---|---|
| Fe 3 - | 75% |
| Ni 3 - | 75% |
| Cr 15 - | 35% |

Moreover, other alloying substances may be present.

FIGS. 3 and 4 illustrate examples of the diffusion of aluminium, FIG. 3, and of copper, FIG. 4, with and without a diffusion barrier. The upper figure of respective figures shows the Al content and the Cu content respectively in the absence of a diffusion barrier, while the other figure of respective figures shows the contents with the addition of a diffusion barrier.

The curves shown in FIGS. 3 and 4 are taken from the result of an EDX-sweep (Energy Dispersive X-ray spectrometry sweep) taken along a line of 900 μm in length. The samples were annealed at a temperature of 900° C. for 200 hours.

The vertical line 6 indicates the original boundary surface between the corrosion-resistant part to the left in both cases and the load-bearing part to the right. The load-bearing part had the following composition in weight percent in both cases:

| | |
|---|---|
| Ni | 60% |
| Cr | 30% |
| Fe | 10% |

This compound has the standard designation UNS NO 6690.

The corrosion-resistant part had the following composition in weight percent:

| | |
|---|---|
| Al | 10.5% |
| Fe | 3.5% |
| Si | 0.04% |
| Cu | The remainder |

A smaller amount of REM may also be present.

The diffusion barrier consisted of pure Fe. The location of the diffusion barrier is marked by the rectangle 7.

As will be evident from FIGS. 3 and 4, the diffusion barrier results in a significant reduction in the diffusion of Al and Cu respectively.

Although the invention has been described with reference to a number of exemplifying embodiments, it will be understood that the two parts and the diffusion barrier may contain low concentrations of additional alloying substances.

It will therefore be understood that the present invention is not restricted to the above exemplifying embodiments since modifications can be made within the scope of the accompanying claims.

1. A composite material intended for components used in corrosive environments, wherein said material comprises a corrosion-resistant part and a load-bearing part, wherein said parts are disposed adjacent one another, wherein the corrosion-resistant part is a copper-aluminium alloy (Cu/Al) and wherein the load- bearing part is comprised of an iron-based (Fe), a nickel-based (Ni) or a cobalt-based (Co) alloy, wherein a diffusion barrier is disposed between the corrosion-resistant part and the load-bearing part, and wherein the diffusion barrier contains one of the substances chromium (Cr) or iron (Fe) or iron (Fe) that contains one of the alloying substances chromium (Cr) or carbon (C).

2. A composite material according to claim 1, wherein the diffusion barrier contains iron together with the alloying element carbon, wherein the amount of carbon present is such that the iron will be austenitic at the temperature used.

3. A composite material according to claim 1, wherein the diffusion barrier contains iron which is alloyed with chromium, wherein the chromium is present in an amount within the range of 1-30% by weight.

4. A composite material according to claim 1, wherein the diffusion barrier has a thickness of at least 10 μm.

5. A composite material according to claim 1, wherein the diffusion barrier has a thickness that does not exceed roughly 25% of the total wall thickness of the composite material.

6. A composite material according to claim 1, wherein the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance: Copper and normally occurring alloying elements and contaminants.

7. A composite material according to claim 1, wherein the load-bearing part has the following composition in percent by weight:

| | |
|---|---|
| Fe | 3-75% |
| Ni | 8-75% |
| Cr | 15-35%. |

8. A composite material according to claim 2, wherein the diffusion barrier has a thickness of at least 10 μm.

9. A composite material according to claim 3, wherein the diffusion barrier has a thickness of at least 10 μm.

10. A composite material according to claim 2, wherein the diffusion barrier has a thickness that does not exceed roughly 25% of the total wall thickness of the composite material.

11. A composite material according to claim 3, wherein the diffusion barrier has a thickness that does not exceed roughly 25% of the total wall thickness of the composite material.

12. A composite material according to claim 4, wherein the diffusion barrier has a thickness that does not exceed roughly 25% of the total wall thickness of the composite material.

13. A composite material according to claim 2, wherein the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance: Copper and normally occurring alloying elements and contaminants.

14. A composite material according to claim 3, wherein the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance: Copper and normally occurring alloying elements and contaminants.

15. A composite material according to claim 4, wherein the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance: Copper and normally occurring alloying elements and contaminants.

16. A composite material according to claim 5, wherein the corrosion-resistant part has the following composition in percent by weight

| | |
|---|---|
| Al | 2-20 |
| Si | >0-6 |
| Fe + Ni + Co + Mn | 0-20 |
| Earth metals | 0-3 |

Balance: Copper and normally occurring alloying elements and contaminants.

17. A composite material according to claim 2, wherein the load-bearing part has the following composition in percent by weight:

| | |
|---|---|
| Fe | 3-75% |
| Ni | 8-75% |
| Cr | 15-35%. |

18. A composite material according to claim 3, wherein the load-bearing part has the following composition in percent by weight:

| | |
|---|---|
| Fe | 3-75% |
| Ni | 8-75% |
| Cr | 15-35%. |

19. A composite material according to claim 4, wherein the load-bearing part has the following composition in percent by weight:

| | |
|---|---|
| Fe | 3-75% |
| Ni | 8-75% |
| Cr | 15-35%. |

20. A composite material according to claim 5, wherein the load-bearing part has the following composition in percent by weight:

| | |
|---|---|
| Fe | 3-75% |
| Ni | 8-75% |
| Cr | 15-35%. |
